(19) United States
(12) Patent Application Publication
(10) Pub. No.: US 2024/0356851 A1
(43) Pub. Date: Oct. 24, 2024

(54) DISAGGREGATION OF NETWORK SERVICES TO HARDWARE-BASED NETWORK DEVICES IN SOFTWARE DEFINED NETWORKS

(71) Applicant: MICROSOFT TECHNOLOGY LICENSING, LLC, Redmond, WA (US)

(72) Inventors: Gerald Roy DE GRACE, Atlanta, GA (US); Rishabh TEWARI, Sammamish, WA (US); Deepak BANSAL, Bellevue, WA (US); Sushant SHARMA, Sammamish, WA (US); Pranjal SHRIVASTAVA, Redmond, WA (US); Avijit GUPTA, Redmond, WA (US); Neeraj MOTWANI, Sammamish, WA (US); Abhijeet KUMAR, Sammamish, WA (US); Chaitanya Kiran RAJE, Seattle, WA (US); Michal Czeslaw ZYGMUNT, Bellevue, WA (US)

(21) Appl. No.: 18/138,729

(22) Filed: Apr. 24, 2023

(51) Int. Cl. H04L 45/76

(52) U.S. Cl. CPC H04L 45/76

(57) ABSTRACT

Techniques are disclosed for processing data packets and implementing policies in a software defined network (SDN) of a virtual computing environment. A plurality of computing nodes are communicatively coupled to network devices. The network devices are configured to enable communications between virtual machines within a virtual network of the virtual computing environment in accordance with associated policies. The network devices and the processing function are disaggregated from dependencies on particular computing nodes that are hosting the virtual machines.

### BACKGROUND

A data center houses computer systems and various networking, storage, and other related components. Data centers, for example, are used by service providers to provide computing services to businesses and individuals as a remote computing service or provide “software as a service” (e.g., cloud computing). Software defined networking (SDN) enables centralized configuration and management of physical and virtual network devices as well as dynamic and scalable implementation of network policies. The efficient processing of data traffic and efficiently utilizing the physical and virtual network devices are important for maintaining scalability and efficient operation in such networks.

It is with respect to these considerations and others that the disclosure made herein is presented.

### SUMMARY

The present disclosure describes various techniques and systems for optimizing the operation of a cloud network to more efficiently utilize computing and networking resources and use less physical space and power by disaggregating cloud network functions from servers. Software defined networks (SDNs) provide managed and privileged software that enables secure separation of data and applications between users of cloud networks via policies. Many cloud architectures offload networking stack tasks for implementing policies such as tunneling for virtual networks. By offloading packet processing tasks to hardware-based network devices such as a smart network interface card (sNIC) or an SDN appliance or data processing unit (DPU) comprising multiple sNICs, the capacity of CPU cores can be reserved for running cloud services and reducing latency and variability to network performance. However, many networking services that are implemented in SDNs such as firewalls, load balancers, application gateways, edge services, etc. are still performed by host servers in software via virtual machines. This can result in inefficient use of computing resources and limit network bandwidth.

While virtual machines running on computing devices can be used to perform the above-described functions as well as other functions, having to connect to a server VM and be looped back into the network can cause a communications bottleneck that adds latency. Furthermore, the cost of servers can be high in contrast to some of the functions being offloaded to dedicated custom hardware.

The disclosed embodiments provide a way to disaggregate networking services to hardware-based network devices such as a smart network interface card (sNIC) or an SDN appliance or data processing unit (DPU) comprising multiple sNICs in order to increase efficiency and reduce consumption of core processing and other resources. Disaggregation of networking services refers to allocation of networking functions so that they need not be performed and co-located within any particular virtual machine on a general-purpose server.

The disclosed embodiments provide a way for hardware-based network devices to perform these additional networking services, for example in the SDN appliance or DPU, and disaggregate these functions from VMs running on server hosts and completely disassociating the need to form connections to the VMs. The hardware-based network device can perform these functions without the need to invoke software-based processing in VMs. For example, the DASH (Disaggregated APIs for SONIC Hosts) device, for example, can be used to house and offer networking and application services without user traffic having to enter a server host, greatly reducing cost and latency.

The described techniques can allow for virtual computing environments to support a variety of configurations while maintaining efficient use of computing resources such as processor cycles, memory, network bandwidth, and power. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2 is a diagram illustrating a data center in accordance with the present disclosure.

FIG. 3 is a diagram illustrating an architecture for implementing virtual services in accordance with the present disclosure;

FIG. 4 is a diagram illustrating an example network interface card in accordance with the present disclosure:

FIG. 5 is a diagram illustrating an example architecture in accordance with the present disclosure:

FIG. 6 is a diagram illustrating an example architecture in accordance with the present disclosure:

FIG. 7 is a diagram illustrating an example architecture in accordance with the present disclosure:

FIG. 8 is a diagram illustrating an example architecture in accordance with the present disclosure:

FIG. 9 is a flowchart depicting an example procedure in accordance with the present disclosure:

FIG. 10 is an example computing system in accordance with the present disclosure.

### DETAILED DESCRIPTION

Cloud service providers typically offer services by providing portions of computing or storage services for selected periods of time or even semi-permanently to users of the cloud. Such services require that one user cannot access another user's data in the form of compute, storage, or any application. To provide such services, cloud providers run managed and privileged software that enables this separation. This software can run on servers at a privileged level or much of it can be moved to a SmartNIC providing similar isolation services between virtual machines or applications running on the server.

The disclosed embodiments enable datacenters to provide services in a manner that can enhance system flexibility and efficiency while reducing cost and complexity, allowing for more efficient use of computing, storage, and network resources. Efficient implementation of the end-to-end services by a cloud service provider can enable an experience that is seamless and more consistent across various footprints. The effective distribution of the described disaggregation and pooling techniques can also be determined based on the implications for various performance and security implications such as latency and data security.

The various embodiments disclosed herein provide a way to efficiently disaggregate and pool network and connectivity services to optimize the allocation of services to hardware-based processing. Some embodiments may use a Smart Network Interface Card (“SmartNIC”), which may be a hardware-based acceleration device that implements various ways of leveraging hardware acceleration and offloading techniques to perform a function, such as implementing tasks in hard ASIC logic, implementing tasks in soft (configurable) FPGA logic, implementing some tasks as software on FPGA software processor overlays, implementing some tasks as software on hard ASIC processors, or a combination thereof. In some embodiments, the hardware-based acceleration device is a network communications device, such as a network interface card (NIC). The NIC is configured to perform complex processing. Such a NIC is referred to herein as a SmartNIC or sNIC.

Cloud computing providers typically use a plurality of racks of servers to provide services in the cloud environment. A typical computing rack of a cloud service provider may have at least one top-of-rack (ToR) switch (two or more if redundancy is provided) and a number of servers. In some architectures, the servers are provisioned with one or more SmartNICs. The SmartNICs allow for each virtual machine (VM) to communicate to any other VM through various types of virtual tunnelling mechanisms. This ensures that a virtual network can be instantiated where data communications are contained within the virtual network boundaries and no other customer's VMs or other external VMs can communicate with it in any way.

Typically, each server is configured to host a number of VMs and include at least one SmartNIC. The SmartNIC provides a virtual interface to every VM hosted on the server. Through the implementation of one or more policies, it is possible for each VM to communicate with any other VM within its virtual network via the policies. These VMs can be on the same server or a different server, and can even be in another datacenter. The policies can be complex and numerous and require a high level of processing and memory associated with their implementation.

In addition to the various forms of isolation services, other networking services for enhancing cloud connectivity include firewalls, load balancers, application gateways, and edge services. In an embodiment, these networking services are implemented on the SmartNICs and looping back to a server is eliminated. Looping back can refer to SmartNIC functionality that requires association with a virtual machine. Tying network functionality to a virtual machine not only requires use of network bandwidth but can use VM allocations that can otherwise be made available for users and other needs.

If SmartNICs can provide full functionality of an application without any interaction with the server, then it is possible to disaggregate the functionality off of the server altogether. A DASH device, for example, could be used to house and provide networking and application services without user traffic ever entering a server, which can decrease latency and cost.

The invention provides a way for hardware-based network devices to perform these additional networking services, for example in the SDN appliance or DPU, and disaggregate these functions from VMs running on server hosts. The hardware-based network device can perform these functions without the need to invoke software-based processing in VMs. For example, the DASH (Disaggregated APIs for SONIC Hosts) device, for example, can be used to house and offer networking and application services without customer traffic ever entering a server host, greatly reducing cost and latency.

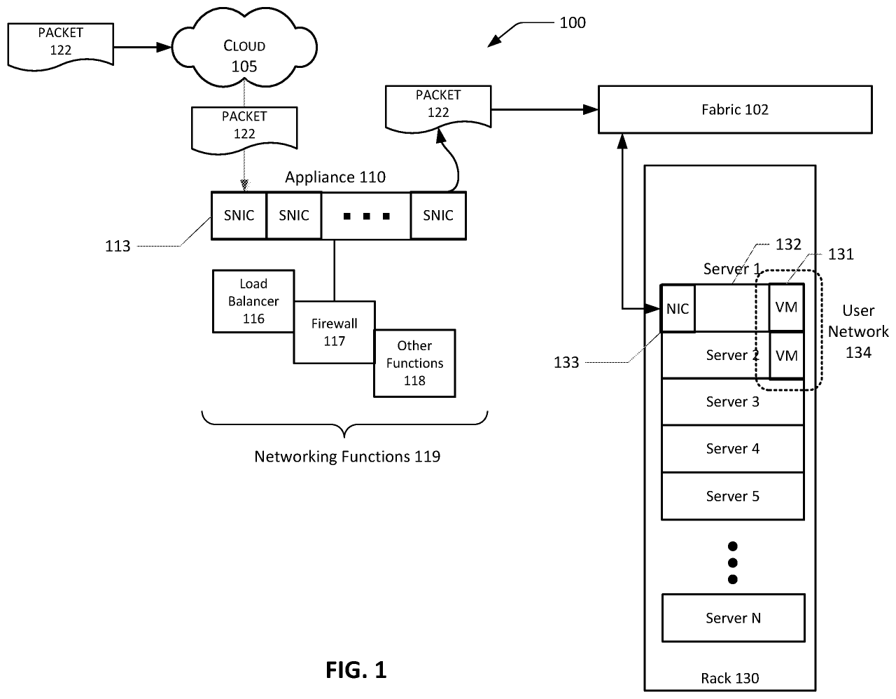

Referring to FIG. 1, illustrated is an example of network function disaggregation, according to an embodiment. A virtualized computing network 100 includes a plurality of computing nodes such as servers 132 that are typically housed in a rack 130. The servers 132 host a plurality of virtual machines 131 and network interface cards (NICs) 133. In one embodiment, virtualized computing network 100 includes a hardware-based network interface device. The hardware-based network interface device is shown this this example as an appliance 110 that includes smartNICs (sNICs) 113. The various illustrated components such as servers 132 and sNICs 113 are configured to implement a software defined network (SDN). At least some of the hardware-based network interface devices are configured to enable communications between the virtual machines 131 within a user network 134 of the virtualized computing network 100 in accordance with associated policies. The appliance 110 receives an input data packet 122, for example via cloud 105. The input data packet 122 can be addressed to an endpoint hosted by a VM 131 of the user network 134. The appliance 110 applies a networking function 119 to the input data packet 122. The networking functions 119 can include load balancer 116, firewall 117, as well as other networking functions 118. The networking functions 119 can each be implemented on one of the sNICs 113, which are disaggregated from physical dependencies on particular computing nodes (e.g., servers 132) that are hosting the virtual machines 131 of the user network 134. The networking functions 119 are also disassociated from logical connections to the plurality of servers 132. The appliance 110 forwards the input data packet 122 to a second hardware-based network interface device such as NIC 133. The NIC 133 is configured to apply a policy associated with the input data packet and the user network. In some embodiments, the forwarding of the input data packet 122 can be facilitated by fabric 102 that can include various networking devices such as switches.

In some embodiments, networking functions can be daisy chained across multiple network hops, where each hop includes a sNIC or other hardware device that implements network functionality as disclosed herein. For example, a first hop may implement a load balancer, a second hop can implement a firewall, a third hop can implement DDOS protection, and so on. The ability to provide different sNIC for floating NIC services across multiple hops (without going through any servers) can allow for implementation of more complex scenarios to support 5G and other services. By using multiple hops, each sNIC or floating NIC can perform a single function in an efficient manner and enable high bandwidth applications without inserting a bottleneck. Functions implemented in floating NICs in the manner described can allow for high bandwidth at each floating NIC implementing a single or potentially additional functions, and daisy chaining through multiple floating NICs can enable great functional complexity while maintaining high bandwidth at each floating NIC. In contrast, looping through multiple servers to provide complex network functionality can introduce significant software latencies substantially lower overall performance. The performance difference is generally due to the fact that SmartNICs (or floating NICs) are optimized around network functions while server complexes are optimized around general computing.

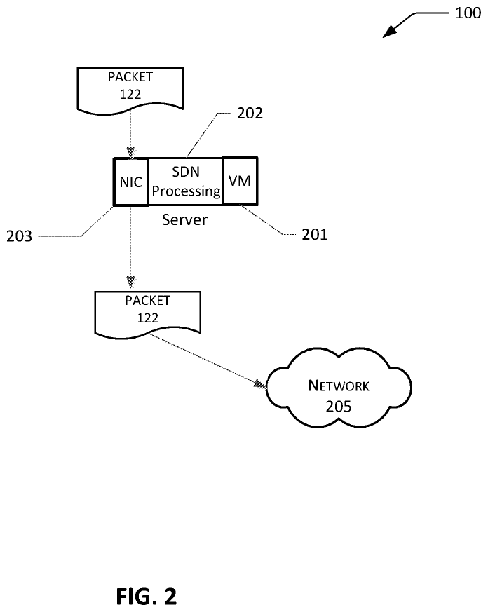

In contrast to the virtualized computing network 100 of FIG. 1, FIG. 2 illustrates a typical computing network where a VM 201 communicates externally through a commodity NIC 203 that supports virtual interfaces and forwards data packets to an SDN policy processing engine 202 before entering the network 205 or vice versa.

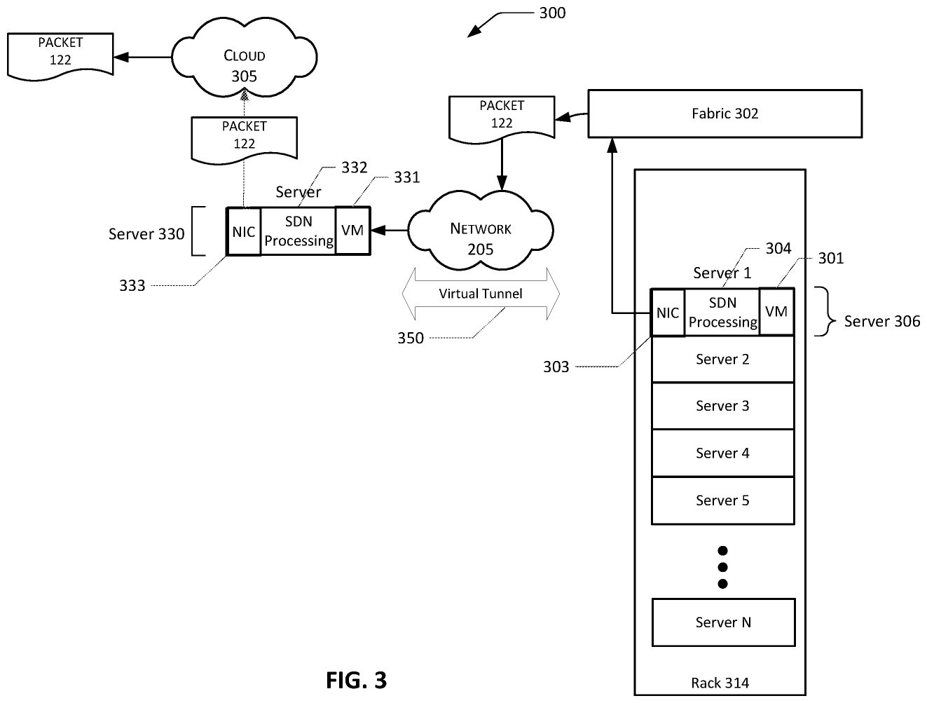

FIG. 3 illustrates that an SDN policy processing engine 304 on server 306 is skipped on the server 306 via a virtual tunnel 350 to enter a remote SDN policy processing engine 332 on server 330, thus freeing up computing and storage resources on the server 306 as well as adding enhanced capabilities for performance and functions that cannot be achieved on the server 306. A virtualized computing network 300 includes a plurality of computing nodes such as servers 306 that are typically housed in a rack 314. The servers 306 host a plurality of virtual machines 301 and network interface cards (NICs) 303. In one embodiment, virtualized computing network 300 includes server 330 that includes NICs 333 and VMs 331. The server 330 receives input data packet 122, for example via cloud 305. The input data packet 122 can be addressed to an endpoint hosted by a VM 301. The server 330 applies SDN processing 332 to the input data packet 122. In some embodiments, the forwarding of the input data packet 122 can be facilitated by fabric 302 that can include various networking devices such as switches.

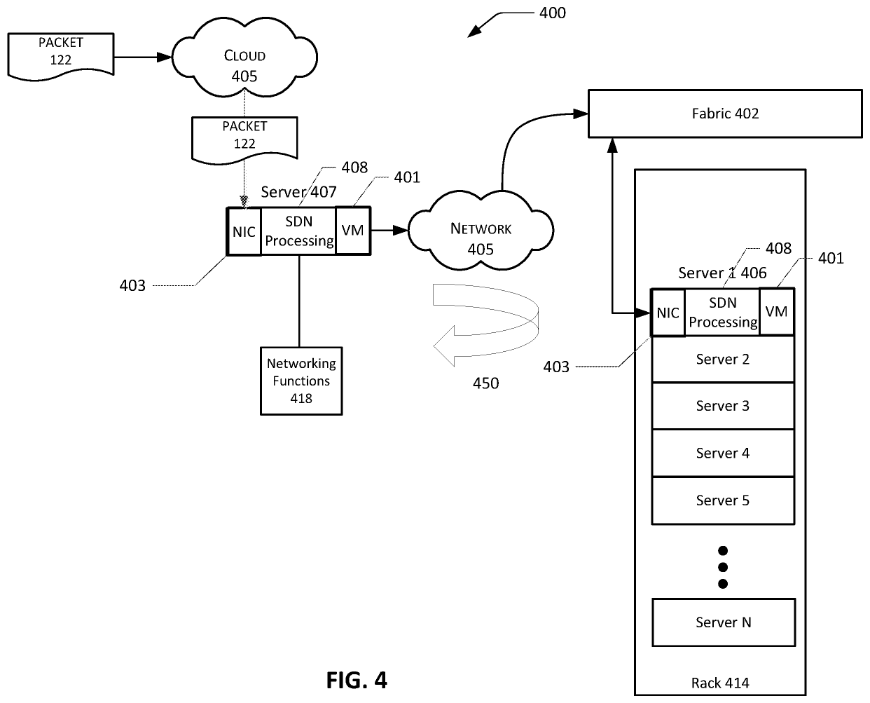

FIG. 4 illustrates that some networking services 418 such as load balancing, firewalls, and gateways are provided by an SDN policy processing engine 408 but must pass through a server VM 401 to be looped back 450 into the network 405 causing a networking bottleneck. A virtualized computing network 400 includes a plurality of computing nodes such as servers 406 that are typically housed in a rack 414. The servers 406 host a plurality of virtual machines 401 and network interface cards (NICs) 403. In one embodiment, virtualized computing network 400 includes server 407 that includes NICs 403 and VMs 401. The server 407 receives input data packet 122. The input data packet 122 can be addressed to an endpoint hosted by a VM 401. The server 407 applies SDN processing 408 to the input data packet 122. In some embodiments, the forwarding of the input data packet 122 can be facilitated by fabric 402 that can include various networking devices such as switches.

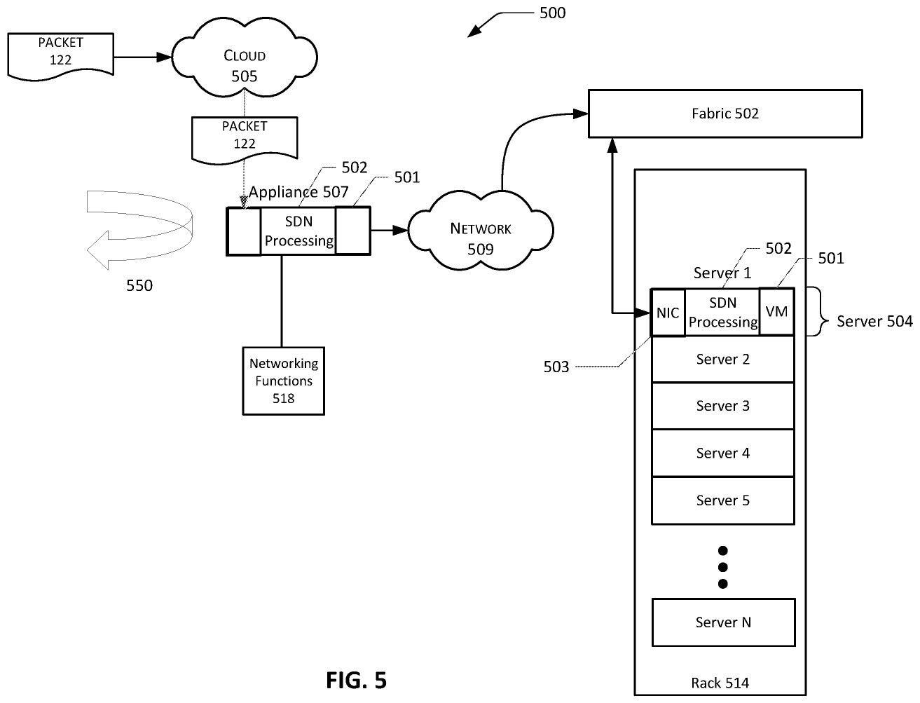

FIG. 5 illustrates that SDN networking functions 518 are performed independently and without any involvement of the server 504 and its components. Examples of such SDN networking functions 518 include load balancing, firewalls, DDOS, vSwitch, edge functions, gateway function, etc. The SDN networking functions 518 can be implemented on a plurality of floating NICs 501 that can be located in cost effective cages, appliances, or switches, such as appliance 507. By implementing the SDN networking functions 518 in appliance 507, higher server costs can be avoided. A virtualized computing network 500 includes a plurality of computing nodes such as servers 504 that are typically housed in a rack 514. The servers 504 host a plurality of virtual machines 501 and network interface cards (NICs) 503. In one embodiment, appliance 507 receives input data packet 122, for example via cloud 505. The input data packet 122 can be addressed to an endpoint hosted by VM 501. The appliance 507 applies networking functions 518 to the input data packet 122. In some embodiments, the forwarding of the input data packet 122 can be sent via network 509 and facilitated by fabric 502 that can include various networking devices such as switches.

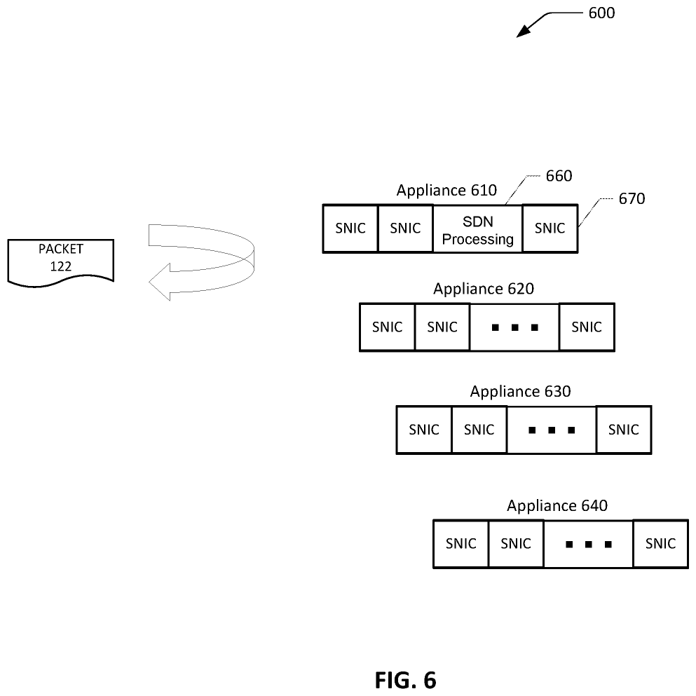

FIG. 6 illustrates that in example network 600, traffic can be spread across multiple SDN policy processing engines 660 that can be implemented on multiple sNICs 670 (e.g., floating NICs) housed on various appliances 610, 620, 630, and 640, to create more capacity for a single application. Implementation of multiple sNICs 670 can be expanded to allow for higher throughputs if required and is only limited to the number of sNICs that the network has access to.

By disaggregating these networking or application services from the server, latency is lowered as loopbacks through the host server's shared software are no longer required. Additionally, power is optimized as the entire networking application runs only on hardware-based network devices. Furthermore, the host server need not dedicate an entire VM resource just to provide a loop back function, allowing for more VMs to be available for other applications. Reduction in cost for the networking services is thus possible by removing the host server from a typical loopback configuration.

In various scenarios, performance is increased by allocating all of a single sNIC or multiple sNICs to a single networking application. This is not possible if the DPU on a server must process traffic for the other VMs entering and exiting the server. Additionally, inserting sNICs on a single server may not be feasible as well as being an inefficient use of resources.

The disclosed embodiments provide a way to disaggregate networking functions to sNICs to increase efficiency and reduce consumption of power and other resources. Disaggregation of networking functions refers to allocation of the networking functions so that they need not be performed or co-located or otherwise have to loop back to any particular server or group of servers. By using sNICs or groupings of sNICs or other dedicated hardware processing unit for networking functions, the compute and transport tasks can be offloaded from the compute servers.

The following are examples of services can be implemented on hardware-based network devices and disaggregated from a host server:

Gateway functions that provide gated services to traffic attempting to access various resources in the cloud.
Layer 4 (L4) and Layer 7 (L7) firewalls.
L4 and L7 load balancers
DDOS services that identify signatures or patterns that can be efficiently handled by DPUs.
Virtual switches providing steering functions based on SDN policies.
Edge functions that require SDN policy enforcement and forwarding.
5G functions that allow for SDN gateway access to standard cloud services
5G functions that allow for multi-cloud connectivity to standard cloud services
Wireless access to standard cloud applications via SDN gateway functions
Remote edge site providing access from an enterprise hybrid cloud to standard public cloud applications.

In the above examples, disaggregation of the services from host servers saves space, power, cost, and substantially reduces complexity. Additionally, if some of these services were developed for implementation on a SmartNIC or DPU that is coupled to a server, such functionality can be ported efficiently to a disaggregated appliance or other configuration with a standalone SmartNIC or DPU. For example, software that was developed to run exclusively on the SmartNIC or DPU can be reprogrammed in the disclosed embodiments. Furthermore, if the SMARTNIC/DPU maintains the same APIs and behavioral models, existing DPUs with the same management/operational software can be used without having to reprogram the DPUs. As SDN management/operational software is complex in nature involving many cooperative software applications, this provides a significant benefit of using this approach. Additionally, disaggregation of the described networking services can be performed in a graduated and non-disruptive manner over time.

In one embodiment, a disaggregated cloud network may include hardware-based network appliances that are configured to provide the above-described networking services. In some embodiments, a single appliance can be programmed to provide the disaggregated functions. Alternatively, the disaggregated functions can be distributed into multiple appliances. Implementation of the disclosed embodiments allows for the functions to be located at any location in the network. For example, the functions can be distributed to another location in the data center or other arbitrary location in accordance with priorities for efficiency and other objectives through the use of logical tunnels to connect functions to provide the services noted above.

Because the described functions are disaggregated, appliance and/or SmartNICs can be added or deleted and swapped out as necessary. Each of the described functions can be designed and deployed optimally for the function and scale required. Additionally, disaggregation enables individual functions to be optimized at their own rate of development.

Disaggregation provides architectural flexibility to take advantage of dedicated processing provided by SmartNICs, smart switches, and/or smart appliances to extend the advantages to other computing and cloud functions. Connecting functions together with logical tunnels enables disaggregation of functions seamlessly across the processing domains. High speed high-capacity network switching enables lower cost of disaggregation with negligible latencies.

As used herein, the functions provided by the SmartNIC/DPU as “floating NICs.” By deploying floating NICs, the capacity requirements of a data center can be planned and services can be leased to users independently of the server fleet. By exposing such services to the users, the users can opt for floating NIC services over similar functions currently only offered on more expensive server platforms. These floating NIC services can be expanded in capacity or reduced in cost relative to current implementations that are coupled with a server. Additionally, floating NICs can expose the lowest latency implementations when required for cloud solutions. For example, financial services and 5G services are examples of services that are sensitive to latency and jitter.

Floating NICs can be deployed as single units or within appliances/switches or other such devices that house a plurality of floating NICs. Appliances and switches can provide efficient housing for DPUs as some services can be evenly spread across multiple floating NICs providing even more flexibility and processing power. Spreading services across floating NICs can easily provide services with significant bandwidth which is difficult to implement on a server with a single SmartNIC/DPU with server interactions. Appliances and switches are also more cost effective as power and cooling in DPUs is more efficient in a centralized solution than housing every DPU separately.

The disclosed embodiments allow for removal of SDN functions from host servers while only implementing new software to provide location services indicating where the floating NICs are located and their availability/capacity for SDN functions.

Referring to the appended drawings, in which like numerals represent like elements throughout the several FIGURES, aspects of various technologies for network disaggregation techniques and supporting technologies will be described. In the following detailed description, references are made to the accompanying drawings that form a part hereof, and which are shown by way of illustration specific configurations or examples.

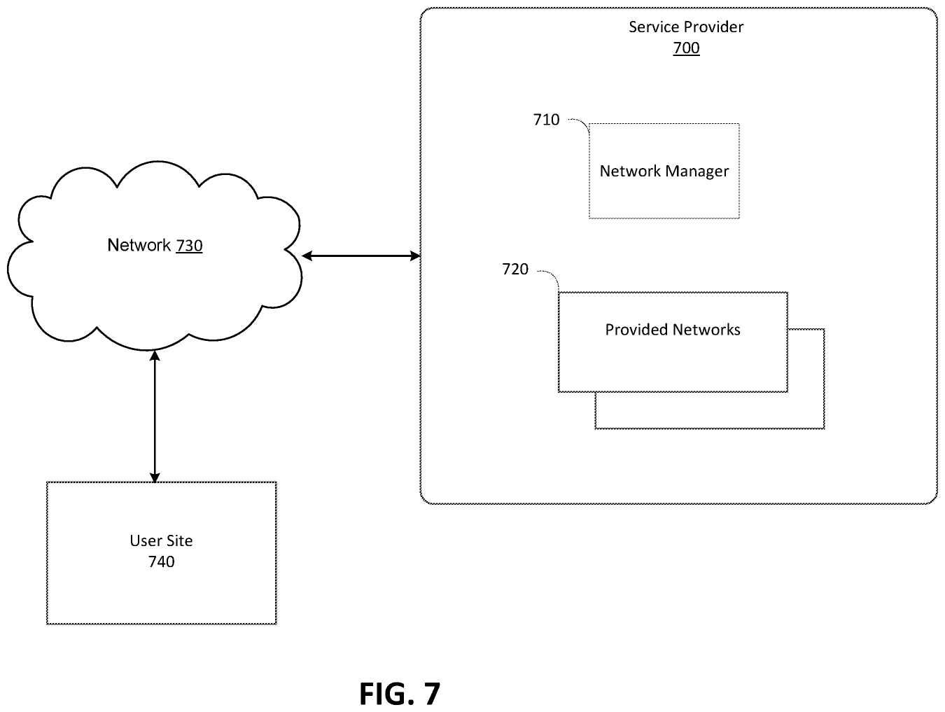

FIG. 7 illustrates an example computing environment in which the embodiments described herein may be implemented. FIG. 7 illustrates a service provider 700 that is configured to provide computing resources to users at user site 740. The user site 740 may have user computers that may access services provided by service provider 700 via a network 730. The computing resources provided by the service provider 700 may include various types of resources, such as computing resources, data storage resources, data communication resources, and the like. For example, computing resources may be available as virtual machines. The virtual machines may be configured to execute applications, including Web servers, application servers, media servers, database servers, and the like. Data storage resources may include file storage devices, block storage devices, and the like. Networking resources may include virtual networking, software load balancer, and the like.

Service provider 700 may have various computing resources including servers, routers, and other devices that may provide remotely accessible computing and network resources using, for example, virtual machines. Other resources that may be provided include data storage resources. Service provider 700 may also execute functions that manage and control allocation of network resources, such as a network manager 710. Service provider 700 may also provide networks accessible at the service provider 700 such as provided networks 720.

Network 730 may, for example, be a publicly accessible network of linked networks and may be operated by various entities, such as the Internet. In other embodiments, network 730 may be a private network, such as a dedicated network that is wholly or partially inaccessible to the public. Network 730 may provide access to computers and other devices at the user site 740.

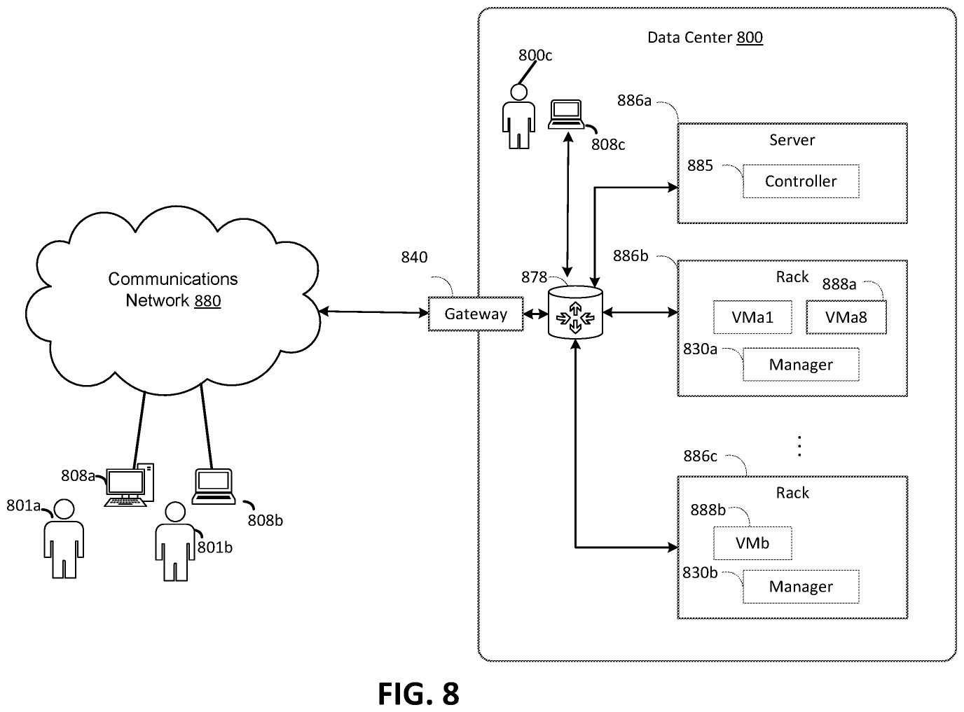

FIG. 8 illustrates an example computing environment in which the embodiments described herein may be implemented. FIG. 8 illustrates a data center 800 that is configured to provide computing resources to users 800a, 800b, or 800c (which may be referred herein singularly as “a user 801” or in the plural as “the users 801”) via user computers 808a, 808b, and 808c (which may be referred herein singularly as “a computer 808” or in the plural as “the computers 808”) via a communications network 880. The computing resources provided by the data center 800 may include various types of resources, such as computing resources, data storage resources, data communication resources, and the like. Each type of computing resource may be general-purpose or may be available in a number of specific configurations. It should be appreciated that although the embodiments disclosed above are discussed in the context of virtual machines, other types of implementations can be utilized with the concepts and technologies disclosed herein, for example containers. For example, computing resources may be available as virtual machines or containers. The virtual machines or containers may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances or containers, such as container instances, virtual machine instances, or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 800 may correspond to network 100 in FIG. 1. Data center 800 may include servers 886a, 886b, and 886c (which may be referred to herein singularly as “a server 886” or in the plural as “the servers 886”) that may be standalone or installed in server racks, and provide computing resources available as virtual machines 888a and 888b (which may be referred to herein singularly as “a virtual machine 888” or in the plural as “the virtual machines 888”). The virtual machines 888 may be configured to execute applications such as Web servers, application servers, media servers, database servers, and the like. Other resources that may be provided include data storage resources (not shown on FIG. 8) and may include file storage devices, block storage devices, and the like. Servers 886 may also execute functions that manage and control allocation of resources in the data center, such as a controller 885. Controller 885 may be a fabric controller or another type of program configured to manage the allocation of virtual machines on servers 886.

Referring to FIG. 8, communications network 880 may, for example, be a publicly accessible network of linked networks and may be operated by various entities, such as the Internet. In other embodiments, communications network 880 may be a private network, such as a corporate network that is wholly or partially inaccessible to the public.

Communications network 880 may provide access to computers 808. Computers 808 may be computers utilized by users 801. Computer 808a, 808b or 808c may be a server, a desktop or laptop personal computer, a tablet computer, a smartphone, a set-top box, or any other computing device capable of accessing data center 800. User computer 808a or 808b may connect directly to the Internet (e.g., via a cable modem). User computer 808c may be internal to the data center 800 and may connect directly to the resources in the data center 800 via internal networks. Although only three user computers 808a,808b, and 808c are depicted, it should be appreciated that there may be multiple user computers.

Computers 808 may also be utilized to configure aspects of the computing resources provided by data center 800. For example, data center 800 may provide a Web interface through which aspects of its operation may be configured through the use of a Web browser application program executing on user computer 808. Alternatively, a stand-alone application program executing on user computer 808 may be used to access an application programming interface (API) exposed by data center 800 for performing the configuration operations.

Servers 886 may be configured to provide the computing resources described above. One or more of the servers 886 may be configured to execute a manager 880a or 880b (which may be referred herein singularly as “a manager 830” or in the plural as “the managers 830”) configured to execute the virtual machines. The managers 830 may be a virtual machine monitor (VMM), fabric controller, or another type of program configured to enable the execution of virtual machines 888 on servers 886, for example.

It should be appreciated that although the embodiments disclosed above are discussed in the context of virtual machines, other types of implementations can be utilized with the concepts and technologies disclosed herein.

In the example data center 800 shown in FIG. 8, a network device 878 may be utilized to interconnect the servers 886a and 886b. Network device 878 may comprise one or more switches, routers, or other network devices. Network device 878 may also be connected to gateway 840, which is connected to communications network 880. Network device 878 may facilitate communications within networks in data center 800, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 8 has been greatly simplified and that many more networks and networking devices may be utilized to interconnect the various computing systems disclosed herein. These network topologies and devices should be apparent to those skilled in the art.

It should also be appreciated that data center 800 described in FIG. 8 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

In some embodiments, aspects of the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

In some of the illustrated example scenarios described herein, SDN capabilities may be enhanced by disaggregating policy enforcement from the host and moving it elsewhere on the network, such as onto an SDN appliance. Software defined networking (SDN) is conventionally implemented on a general-purpose compute node. The SDN control plane may program the host to provide core network functions such as security, virtual network, and load balancer policies. An SDN appliance can be used to host these agents and provide switch functionality, and can further provide transformations and connectivity. The SDN appliance can accept policies that perform transformations. In some embodiments, an agent can be implemented that programs the drivers that run on the SDN appliance. The traffic sent by workloads can be directed through the SDN appliance, which can apply policies and perform transformations on the traffic and send the traffic to the destination. In some configurations, the SDN appliance may include a virtual switch such as a virtual filtering platform.

It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like; c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

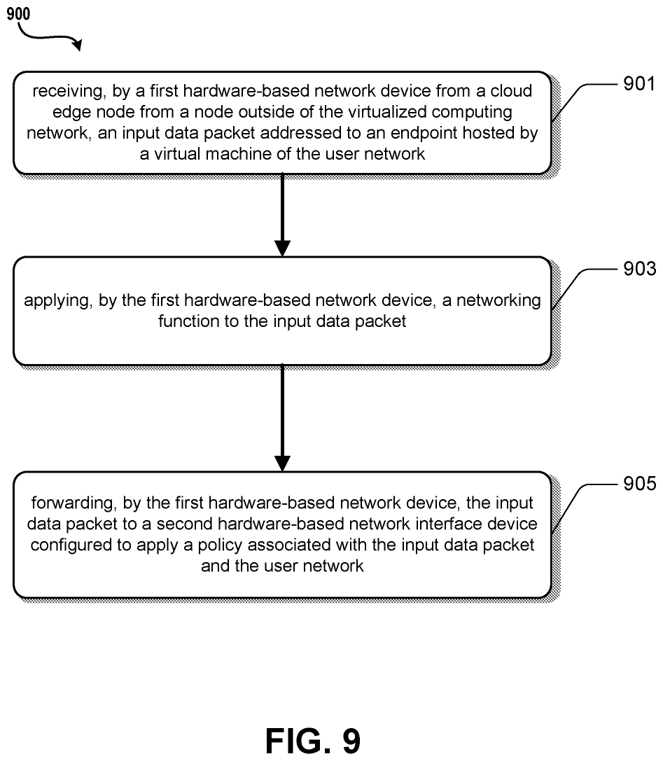

Turning now to FIG. 9, illustrated is an example operational procedure 900 for processing data packets in a virtualized computing network. The virtualized computing network comprises a plurality of computing nodes hosting a plurality of virtual machines and hardware-based network interface devices configured to implement a software defined network (SDN). At least some of the hardware-based network interface devices are configured to enable communications between the virtual machines within a user network of the virtualized computing network in accordance with associated policies. Such an operational procedure can be provided by one or more components illustrated in FIGS. 1 through 8. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 900 is described as running on a system, it can be appreciated that the routine 900 and other operations described herein can be executed on an individual computing device or several devices.

Referring to FIG. 9, operation 901 illustrates receiving, by a first hardware-based network device via a cloud edge node from a source outside of the virtualized computing network, an input data packet addressed to an endpoint hosted by a virtual machine of the user network.

Operation 903 illustrates applying, by the first hardware-based network device, a networking function to the input data packet. In an embodiment, the networking function is disaggregated from physical dependencies on a set of the computing nodes that are hosting the virtual machines of the user network. In an embodiment, the networking function is disassociated from logical connections to the set of the computing nodes.

Operation 905 illustrates forwarding, by the first hardware-based network device, the input data packet to a second hardware-based network interface device configured to apply a policy associated with the input data packet and the user network. This enables the input data packet to be processed by the networking function by the first hardware-based network device prior to being forwarded to any of the virtual machines of the user network.

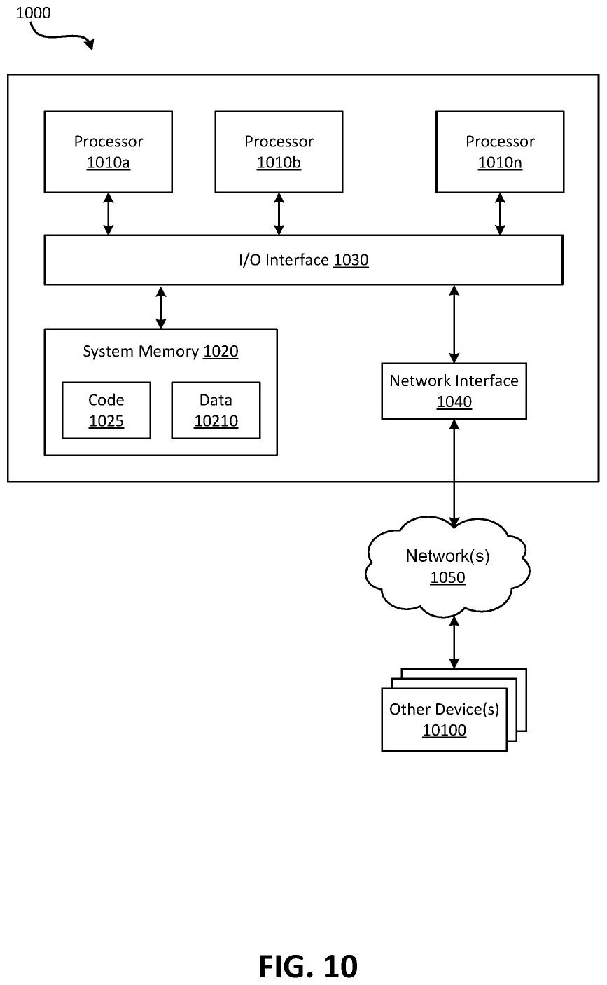

FIG. 10 illustrates a general-purpose computing device 1000. In the illustrated embodiment, computing device 1000 includes one or more processors 1010a, 1010b, and/or 1010n (which may be referred herein singularly as “a processor 1010” or in the plural as “the processors 1010”) coupled to a system memory 1020 via an input/output (I/O) interface 1030. Computing device 1000 further includes a network interface 1040 coupled to I/O interface 1030.

In various embodiments, computing device 1000 may be a uniprocessor system including one processor 1010 or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x1010, PowerPC, SPARC, or MIPS ISAs, or any other suitable ISA. In multiprocessor systems, each of processors 1010 may commonly, but not necessarily, implement the same ISA.

System memory 1020 may be configured to store instructions and data accessible by processor(s) 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 1020 as code 1025 and data 10210.

In one embodiment, I/O interface 1030 may be configured to coordinate I/O traffic between the processor 1010, system memory 1020, and any peripheral devices in the device, including network interface 1040 or other peripheral interfaces. In some embodiments, I/O interface 1030 may perform any necessary protocol, timing, or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components. Also, in some embodiments some or all of the functionality of I/O interface 1030, such as an interface to system memory 1020, may be incorporated directly into processor 1010.

Network interface 1040 may be configured to allow data to be exchanged between computing device 1000 and other device or devices 10100 attached to a network or network(s) 1050, such as other computer systems or devices as illustrated in FIGS. 1 through 5, for example. In various embodiments, network interface 1040 may support communication via any suitable wired or wireless general data networks, such as types of Ethernet networks, for example. Additionally, network interface 1040 may support communication via telecommunications/telephony networks such as analog voice networks or digital fiber communications networks, via storage area networks such as Fibre Channel SANs or via any other suitable type of network and/or protocol.

In some embodiments, system memory 1020 may be one embodiment of a computer-accessible medium configured to store program instructions and data as described above for the Figures for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 1000 via I/O interface 1030. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 1000 as system memory 1020 or another type of memory. Further, a computer-accessible medium may include transmission media or signals such as electrical, electromagnetic or digital signals, conveyed via a communication medium such as a network and/or a wireless link, such as may be implemented via network interface 1040. Portions or all of multiple computing devices, such as those illustrated in FIG. 10, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 10, may include other components that are not explicitly shown in FIG. 10, or may utilize an architecture completely different than that shown in FIG. 10.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

Although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for processing data packets in a virtualized computing network comprising a plurality of computing nodes hosting a plurality of virtual machines and hardware-based network interface devices configured to implement a software defined network (SDN), wherein at least some of the hardware-based network interface devices are configured to enable communications between the virtual machines within a user network of the virtualized computing network in accordance with associated policies, the method comprising:
receiving, by a first hardware-based network device via a cloud edge node from a source outside of the virtualized computing network, an input data packet addressed to an endpoint hosted by a virtual machine of the user network;
applying, by the first hardware-based network device, a networking function to the input data packet, wherein the networking function is disaggregated from physical dependencies on a set of the computing nodes that are hosting the virtual machines of the user network and wherein the networking function is disassociated from logical connections to the set of the computing nodes; and
forwarding, by the first hardware-based network device, the input data packet to a second hardware-based network interface device configured to apply a policy associated with the input data packet and the user network, thereby enabling the input data packet to be processed by the networking function by the first hardware-based network device prior to being forwarded to any of the virtual machines of the user network.

Clause 2: The method of clause 1, wherein the first and second hardware-based network devices are physically distributed in the virtualized computing network and configured as a pooled resource.

Clause 3: The method of any of clauses 1-2, wherein a plurality of the networking functions are executed in a plurality of the hardware-based network devices.

Clause 4: The method of any of clauses 1-3, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

Clause 5: The method of any of clauses 1-4, wherein the first hardware-based network device is a smart network interface card (sNIC).

Clause 6: The method of any of clauses 1-5, wherein the first hardware-based network device is an appliance comprising a plurality of smart network interface cards (sNICs).

Clause 7: The method of any of clauses 1-5, further comprising applying a plurality of networking functions by the plurality of sNICs.

Clause 8: A network appliance comprising:
a plurality of hardware-based network devices configured to disaggregate network functions of a SDN of a virtual computing network from hosts of the virtual computing network, the hosts implemented on servers hosting a plurality of virtual machines;
the network appliance configured to:
receive an input data packet addressed to an endpoint hosted by a virtual machine of a user network implemented by the plurality of virtual machines;
apply a network function to the input data packet, wherein the network function is disaggregated from physical dependencies on servers that are hosting virtual machines of the user network and wherein the network function is disassociated from logical connections to the virtual machines of the user network; and
forward the input data packet to a network interface device configured to apply a policy associated with the input data packet and the user network.

Clause 9: The system of clause 8, wherein the plurality of hardware-based network devices are physically distributed in the virtualized computing network and configured as a pooled resource.

Clause 10: The system of any of clauses 8 and 9, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

Clause 11: The hardware-based networking device of any clauses 8-10, wherein the network interface device is a smart network interface card (sNIC).

Clause 12: The hardware-based networking device of any clauses 8-11, wherein the network appliance comprises a plurality of smart network interface cards (sNICs).

Clause 13: The hardware-based networking device of any clauses 8-12, further comprising applying a plurality of networking functions by the plurality of sNICs.

Clause 14: A network device configured to disaggregate network functions of a 5G network from hosts of the 5G network, the hosts implemented on servers hosting a plurality of virtual machines or containers, the network device comprising a plurality of processing units configured to implement functionality of the network device, the network device configured to:
receive an input data packet addressed to an endpoint hosted by a virtual machine or container of a user network implemented by the plurality of virtual machines or containers;
apply a network function to the input data packet, wherein the network function is disaggregated from physical dependencies on servers that are hosting virtual machines or containers of the user network and wherein the network function is disassociated from logical connections to the virtual machines or containers of the user network; and
forward the input data packet to a network interface device configured to apply a policy associated with the input data packet and the user network.

Clause 15: The network device of clause 14, wherein the plurality of processing units are configured as a pooled resource.

Clause 16: The network device of any of clauses 14 and 15, wherein a plurality of the networking functions are executed in the network device.

Clause 17: The network device of any of clauses 14-16, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

Clause 18: The network device of any of clauses 14-17, further comprising a smart network interface card (sNIC).

Clause 19: The network device of any of clauses 14-18, further comprising a plurality of smart network interface cards (sNICs).

Clause 20: The network device of any of clauses 14-19, further comprising applying a plurality of networking functions by the plurality of sNICs.

What is claimed is:

1. A method for processing data packets in a virtualized computing network comprising a plurality of computing nodes hosting a plurality of virtual machines and hardware-based network interface devices configured to implement a software defined network (SDN), wherein at least some of the hardware-based network interface devices are configured to enable communications between the virtual machines within a user network of the virtualized computing network in accordance with associated policies, the method comprising:
receiving, by a first hardware-based network device via a cloud edge node from a source outside of the virtualized computing network, an input data packet addressed to an endpoint hosted by a virtual machine of the user network;
applying, by the first hardware-based network device, a networking function to the input data packet, wherein the networking function is disaggregated from physical dependencies on a set of the computing nodes that are hosting the virtual machines of the user network and wherein the networking function is disassociated from logical connections to the set of the computing nodes; and
forwarding, by the first hardware-based network device, the input data packet to a second hardware-based network interface device configured to apply a policy associated with the input data packet and the user network, thereby enabling the input data packet to be processed by the networking function by the first hardware-based network device prior to being forwarded to any of the virtual machines of the user network.

2. The method of claim 1, wherein the first and second hardware-based network devices are physically distributed in the virtualized computing network and configured as a pooled resource.

3. The method of claim 1, wherein a plurality of the networking functions are executed in a plurality of the hardware-based network devices.

4. The method of claim 1, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

5. The method of claim 1, wherein the first hardware-based network device is a smart network interface card (sNIC).

6. The method of claim 1, wherein the first hardware-based network device is an appliance comprising a plurality of smart network interface cards (sNICs).

7. The method of claim 6, further comprising applying a plurality of networking functions by the plurality of sNICs.

8. A network appliance comprising:
a plurality of hardware-based network devices configured to disaggregate network functions of a SDN of a virtual computing network from hosts of the virtual computing network, the hosts implemented on servers hosting a plurality of virtual machines;
the network appliance configured to:
receive an input data packet addressed to an endpoint hosted by a virtual machine of a user network implemented by the plurality of virtual machines;
apply a network function to the input data packet, wherein the network function is disaggregated from physical dependencies on servers that are hosting virtual machines of the user network and wherein the network function is disassociated from logical connections to the virtual machines of the user network; and
forward the input data packet to a network interface device configured to apply a policy associated with the input data packet and the user network.

9. The network appliance of claim 8, wherein the plurality of hardware-based network devices are physically distributed in the virtualized computing network and configured as a pooled resource.

10. The network appliance of claim 8, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

11. The network appliance of claim 8, wherein the network interface device is a smart network interface card (sNIC).

12. The network appliance of claim 8, wherein the network appliance comprises a plurality of smart network interface cards (sNICs).

13. The network appliance of claim 12, further comprising applying a plurality of networking functions by the plurality of sNICs.

14. A network device configured to disaggregate network functions of a 5G network from hosts of the 5G network, the hosts implemented on servers hosting a plurality of virtual machines or containers, the network device comprising a plurality of processing units configured to implement functionality of the network device, the network device configured to:
receive an input data packet addressed to an endpoint hosted by a virtual machine or container of a user network implemented by the plurality of virtual machines or containers;
apply a network function to the input data packet, wherein the network function is disaggregated from physical dependencies on servers that are hosting virtual machines or containers of the user network and wherein the network function is disassociated from logical connections to the virtual machines or containers of the user network; and
forward the input data packet to a network interface device configured to apply a policy associated with the input data packet and the user network.

15. The network device of claim 14, wherein the plurality of processing units are configured as a pooled resource.

16. The network device of claim 14, wherein a plurality of the networking functions are executed in the network device.

17. The network device of claim 14, wherein the networking functions comprise one or more of gateway functions configured to provide gated services to traffic attempting to access resources in the virtualized computing network, Layer 4 (L4) firewalls, Layer 7 (L7) firewalls, L4 load balancers, L7 load balancers, distributed denial-of-service (DDoS) services, virtual switches providing steering functions based on SDN policies, edge functions that require SDN policy enforcement and forwarding, 5G functions that allow for SDN gateway access to cloud services, 5G functions that allow for multi-cloud connectivity to cloud services, wireless access to cloud applications via SDN gateway functions, or providing access from a remote edge site to cloud applications.

18. The network device of claim 14, further comprising a smart network interface card (sNIC).

19. The network device of claim 18, further comprising a plurality of smart network interface cards (sNICs).

20. The network device of claim 19, further comprising applying a plurality of networking functions by the plurality of sNICs.
